(19) United States
(12) Patent Application Publication
(10) Pub. No.: US 2017/0190144 A1
(43) Pub. Date: Jul. 6, 2017

(54) DEGASSING SHEET, BAG BODY USING DEGASSING SHEET, AND DEGASSING CONTAINER SEALING MEMBER

(71) Applicant: W & Co., Tokyo (JP)

(72) Inventor: Hiroyuki ITO, Tokyo (JP)

(73) Assignee: W & Co.

(21) Appl. No.: 15/358,145

(22) Filed: Nov. 22, 2016

(30) Foreign Application Priority Data
Jan. 6, 2016 (JP) 2016-000850

(51) Int. Cl. B32B 7/14; B32B 3/26; B32B 27/08; B65D 33/01; B32B 27/36; B32B 27/30; B65D 65/40; B32B 1/02; B32B 27/32

(52) U.S. Cl. CPC B32B 7/14; B32B 1/02; B32B 3/266; B32B 27/08; B32B 27/32; B32B 27/36; B32B 27/306; B32B 27/304; B65D 65/40; B65D 33/01; B32B 2250/02; B32B 2250/24; B32B 2255/10; B32B 2255/205; B32B 2307/7244; B32B 2439/70

(57) ABSTRACT

To provide degassing sheet that exhibits a stable gas venting operation in accordance with different generation amounts of carbon dioxide gas and yet provides a gas venting effect even when an internal pressure of a storage bag is low. A fully-penetrating or semi-penetrating penetrating hole 4 is formed in a gas-permeable film 2A. A paste is coated on a barrier film 2B to form an adhesion layer 3. The gas-permeable film 2A is overlapped onto the adhesion layer 3. Non-adhered portions 3B, forming a striped pattern, are formed continuously in the adhesion layer 3. The non-adhered portions 3B form degassing ports.

### CROSS-REFERENCES TO RELATED APPLICATIONS

This patent specification is based on Japanese patent application, No. 2016-000850 filed on Jan. 6, 2015 in the Japan Patent Office, the entire contents of which are incorporated by reference herein.

### BACKGROUND OF THE INVENTION

1. Field of the Invention

The present invention relates to a degassing sheet, capable of storing a food product, such as coffee beans, miso, etc., and degassing carbon dioxide gas generated from the food product while it is packaged, a method for forming the degassing sheet, and a bag body that uses the degassing sheet.

2. Description of the Related Art

For example, when coffee beans are bagged, carbon dioxide gas generated from the coffee beans may fill an interior of the bag and the bag may burst. Therefore conventionally, a special valve is installed on the bag and appropriate gas venting is performed to adjust an internal pressure of the bag.

With a bag installed with such a special valve, the arrangement of the valve is bulky and a problem of unevenness forming on a surface of the bag arises. Moreover, due to the bag being installed with the valve, as a separate member, a manufacturing cost becomes extremely high.

On the other hand, a packaging bag exhibiting a gas venting operation is described in Patent Document 1. With the packaging bag, a non-breathable outer film having oxygen barrier property and a breathable inner film that allows permeation of oxygen are overlapped and a gas venting hole portion is provided in the outer film.

However, with the packaging bag described in Patent Document 1, numerous processes are required in manufacturing the film exhibiting the gas venting operation because the outer film having the oxygen barrier property is overlapped with the inner film with breathability.

The present applicant has thus proposed a degassing bag for food product, with which, at a portion where inner films of packaging films forming a bag body are joined to each other, a gas venting hole portion is penetratingly formed in advance in one of the packaging films as described in Patent Document 2.

With the degassing bag for food product, a hole portion is not formed in a main body portion of a bag body and therefore a degassing bag for food product with good appearance is provided successfully. Also, the hole portion is formed at the portion at which the inner films are joined to each other and therefore a possibility of deformation of the hole portion is also resolved.

However, with the degassing bag for food product described in Patent Document 2, the gas venting hole portion that is penetratingly formed in the packaging film is penetrated through one of the packaging films at the joined portion, and therefore two films that are overlapped must be semi-penetrated by laser processing. There is thus an issue of the laser processing being difficult and processing of the hole portion being unstable.

Moreover, when the gas venting hole portion is disposed partially, degassing cannot be performed unless an internal pressure becomes not less than 25 atm and it was thus difficult to degas in accordance with different generation amounts of carbon dioxide gas, as in cases of coffee beans and fermented foods, etc.

The present applicant thus further invented a degassing bag for food product, which, as described in Patent Document 3, exhibits a stable gas venting operation in accordance with different generation amounts of carbon dioxide gas and yet provides a gas venting effect even when an internal pressure of a storage bag, etc., is low.

With the degassing bag for food product of Patent Document 3, a degassing layer is constituted of a polyethylene layer and an oxygen barrier layer and a gas venting penetrating hole is opened to penetrate through the degassing layer. And an arrangement is provided where non-adhered portions, forming a striped pattern, are formed continuously in an adhesion layer adhering a packaging film layer and the oxygen barrier layer of the degassing layer and the non-adhered portions form degassing ports in communication with the exterior of the storage bag.

[Patent Document 1] Japanese Published Unexamined Patent Application No. H10-167335

### [Patent Document 2] Japanese Utility Model Registration No. 3184474

### [Patent Document 3] Japanese Patent No. 5770356

### BRIEF SUMMARY OF THE INVENTION

The present invention further improves on the degassing bag for food product described in Patent Document 3 and an object thereof is to provide a degassing sheet, which exhibits a stable gas venting operation in accordance with different generation amounts of carbon dioxide gas and yet provides a gas venting effect even when an internal pressure of a storage bag, etc., is low, a method for forming the degassing sheet, and a bag body using the degassing sheet.

In order to achieve the above object, a first means according to the present invention is a degassing sheet constituted of a gas-permeable film 2A, having a fully-penetrating or semi-penetrating penetrating hole 4 formed therein, and a barrier film 2B, provided with an adhesion layer 3 having a paste coated on an inner side, and being arranged so that non-adhered portions 3B, forming a striped pattern, are formed continuously in the adhesion layer 3 of the barrier film 2B and the non-adhered portions 3B form degassing ports between the gas-permeable film 2A, adhered to the adhesion layer 3, and the barrier film 2B.

With a second means, a thickness of the gas-permeable film 2A is set to be not less than 10 μm and not more than 400 μm.

With a third means, the gas-permeable film 2A is constituted from polyethylene with a density of not more than 0.94.

With a fourth means, the barrier film 2B is arranged as a barrier film 2B selected from among aluminum foil, aluminum deposited film, alumina deposited film, silica deposited film, polyvinyl alcohol film, and vinylidene chloride film.

With a fifth means, a shape of the penetrating hole 4 provided in the gas-permeable film 2A is elliptical or rectangular.

With a sixth means, a width of each non-adhered portion 3B of the adhesion layer 3 is set to be from 0.3 mm to 0.95 mm.

A seventh means is a degassing bag body using a degassing sheet that is formed using the degassing sheet according to any one of the first means to the sixth means so that the barrier film 2B is an outer layer.

An eighth means is a degassing container sealing member using a degassing sheet that is formed using the degassing sheet according to any one of claim 1 to claim 6 so that the barrier film 2B is an outer layer.

A ninth means is a method for forming a degassing sheet with a step of forming a fully-penetrating or semi-penetrating penetrating hole 4 in a gas-permeable film 2A, a step of coating a paste in stripe form on a barrier film 2B to provide an adhesion layer 3 and forming non-adhered portions 3B, forming a striped pattern, in the adhesion layer 3, a step of adhering the gas-permeable film 2A to the adhesion layer 3 of the barrier film 2B, and a step of forming degassing ports of stripe form between the gas-permeable film 2A and the barrier film 2B, the steps being performed in the above order.

With the degassing sheet according to the first to sixth means, a gas venting effect is provided regardless of a change of internal pressure of a storage bag 10. Consequently, stable gas venting is enabled in accordance with different generation amounts of carbon dioxide gas. Consequently, degassing is enabled even when the internal pressure is approximately latm and degassing can be performed in accordance with different generation amounts of carbon dioxide gas, as in cases of coffee beans and fermented foods, etc.

With the degassing bag body according to the seventh means, a degassing bag body that enables stable gas venting in accordance with different generation amounts of carbon dioxide gas can be provided.

With the sealing member according to the eighth means, a degassing container sealing member that enables stable gas venting in accordance with different generation amounts of carbon dioxide gas can be provided.

With the method for forming according to the ninth means, a degassing sheet that enables stable gas venting in accordance with different generation amounts of carbon dioxide gas can be formed. Also, a smooth surface is provided because there is no degassing valve and excellence in design is also realized because a degassing hole is not visible.

### BRIEF DESCRIPTION OF THE DRAWINGS

FIG. 1 is a rear view of an embodiment of a bag body according to the present invention.

FIG. 2 is a sectional view of a principal portion in a state where a hole portion is penetratingly formed in a degassing sheet according to the present invention.

FIG. 3 is a sectional view of a principal portion in a state where a hole portion is provided in a heat sealed portion according to the present invention.

FIG. 4 is a sectional view of the principal portion in the state where the hole portion is provided in the heat sealed portion according to the present invention.

### DETAILED DESCRIPTION OF THE INVENTION

As described above, by the present invention, the original object of exhibiting a stable gas venting operation in accordance with different generation amounts of carbon dioxide gas and yet providing a gas venting effect even when an internal pressure of a storage bag, etc., is low, etc., is realized.

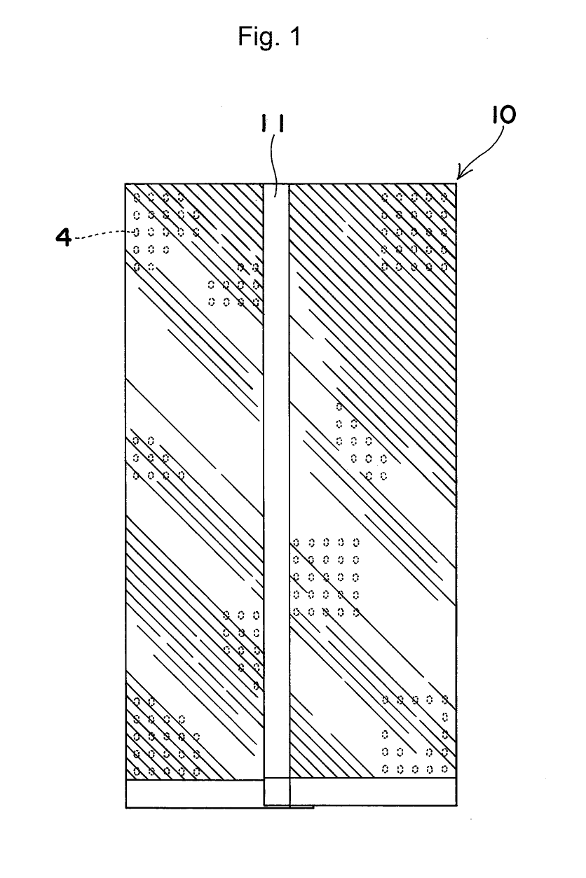

An embodiment of the present invention shall now be described. The present invention relates to a degassing sheet favorable for forming, for example, a storage bag 10 (see FIG. 1), capable of storing coffee beans, miso, or other food products from which carbon dioxide gas is generated, a sealing member, etc., capping an opening portion of a degassing container

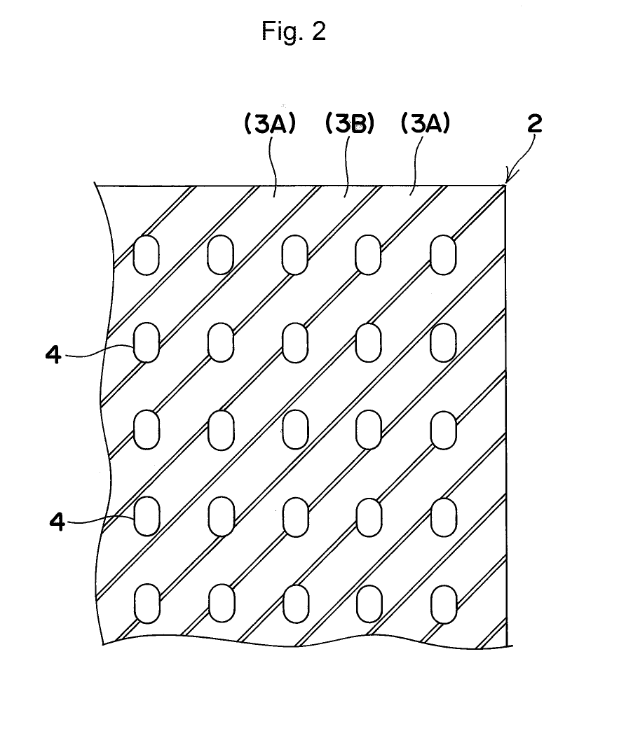

With the degassing sheet 2, a gas-permeable film 2A and a barrier film 2B are overlapped. Fully-penetrating or semi-penetrating penetrating holes 4 are formed in the gas-permeable film 2A. On the other hand, an adhesion layer 3, with paste coated thereon, is formed on the barrier film 2B and the degassing sheet is arranged by overlapping the adhesion layer 3 onto an outer side of the gas-permeable film 2A. In this process, non-adhered portions 3B, forming a striped pattern, are formed continuously in the adhesion layer 3 and the non-adhered portions 3B forms degassing ports (see FIG. 2).

Although the material of the gas-permeable film 2A is not restricted in particular, polyethylene is preferable. Among polyethylenes, a so-called low density polyethylene with a density of 0.91 to 0.93 is especially preferable in terms of breathability. Polyethylenes and low density polyethylenes are described, for example, in Purasuchikku Katsuyo Noto (“Notes on Plastic Utilization”; Kogyo Chosakai Publishing Co., Ltd., fifth edition published in 1984).

Also, a thickness of the gas-permeable film 2A is not less than 10 μm and not more than 400 μm and especially preferably not less than 15 μm and not more than 100 μm. If the thickness is less than 10 μm, the strength may be insufficient in some cases and on the other hand, if the thickness exceeds 400 μm, the breathability may be insufficient in some cases.

The fully-penetrating or semi-penetrating penetrating holes 4 are formed in the gas-permeable film 2A. Although the shape of each of the illustrated penetrating holes 4 is an oval shape, the shape may be changed arbitrarily to an elliptical shape or rectangular shape, etc.

On the other hand, the adhesion layer 3, with the paste coated thereon, is formed on an inner side of the barrier film 2B, which is overlapped onto the outer side of the gas-permeable film 2A, and the degassing sheet is arranged by overlapping the adhesion layer 3 onto the outer side of the gas-permeable film 2A. In this process, the non-adhered portions 3B, forming the striped pattern, are formed continuously in the adhesion layer 3. The non-adhered portions 3B form the degassing port in communication with the penetrating holes 4. A width of each non-adhered portion 3B is set to be from 0.3 mm to 0.95 mm. When, as described above, the width of each non-adhered portion 3B is not less than 0.3 mm, satisfactory breathability is provided, and when the width is not more than 0.95 mm, sufficient strength is provided.

The material of the barrier film 2B is a so-called barrier film of extremely lower gas permeability than the gas-permeable film 2A. Examples of the barrier film 2B include aluminum foil, aluminum deposited film, alumina deposited film, silica deposited film, polyvinyl alcohol film, vinylidene chloride film, etc.

Among these materials, the aluminum deposited film, the alumina deposited film, and the silica deposited film respectively have aluminum, alumina, and silica vacuum vapor deposited on a polymer base material. Polyethylene terephthalate is often used as the polymer base material. In some cases, these may be adhered onto yet another polymer film to arrange the barrier film.

Also, the polyvinyl alcohol film is an approximately 10 to 200 μm film of polyvinyl alcohol or has an approximately 10 to 200 μm polyvinyl alcohol layer provided on a polymer base material. There is no restriction in particular in regard to a method for providing the polyvinyl alcohol layer and a method such as coating, etc., may be used. As the polyvinyl alcohol, it is preferable to use that with a saponification degree of approximately 60 to 99.7.

Further, the polyvinylidene chloride film is an approximately 10 to 200 μm film of polyvinylidene chloride or has an approximately 10 to 200 μm polyvinylidene chloride layer provided on a polymer base material. As the polyvinylidene chloride, a homopolymer of vinylidene chloride or a copolymer of this and acrylic monomer, acrylonitrile, vinyl chloride, etc., may be used. A molar ratio of vinylidene chloride in the copolymer is preferably approximately 50 to 98 mol %. Also, it is preferable in terms of barrier property for the vinylidene chloride of the polyvinylidene chloride film to be partially crystallized.

Besides the above, the barrier film 2B may be a transparent film, such as the aluminum deposited film, alumina deposited film, and the silica deposited film, or may be a nontransparent film, such as the aluminum foil. Although a thickness of the barrier film 2B is not restricted in particular, that of approximately 20 to 400 μm is preferable in terms of strength and cost. An outer film of the present invention may be that with which the barrier film is adhered together with another film.

The method for forming according to the present invention has the following steps. That is, the steps are a step of forming the fully-penetrating or semi-penetrating penetrating holes 4 in the gas-permeable film 2A, a step of coating the paste in stripe form on the barrier film 2B to provide the adhesion layer 3 and forming the non-adhered portions 3B, forming the striped pattern, in the adhesion layer 3, a step of adhering the gas-permeable film 2A to the adhesion layer 3 of the barrier film 2B, and a step of forming the degassing port of stripe form between the gas-permeable film 2A and the barrier film 2B, and these steps are performed in succession.

With the present invention, the barrier film 2B of such a degassing sheet is arranged to be an outer layer to form a degassing bag body or form a degassing container sealing member. In a case of forming the sealing member, the sealing member is a member that covers a portion of a container and is especially preferably that which is used as a lid. The container is a container constituted of plastic or other raw material and is used for containing a food product, etc. The container using the degassing sheet of the present invention as a sealing member for a lid has breathability and is capable of keeping a pressure of an interior of the container fixed. With a bag body, in cases of a content of paste form, such as miso, the content may, in some cases, become attached to an inner side of the bag body and breathability may decrease slightly. On the other hand, with the present container, even in cases of a content of paste form, there is a gap between the content and the lid and therefore the breathability will not be compromised.

With the illustrated example, a degassing bag body is formed using the degassing sheet of the present invention. That is, the bag body is a storage bag 10 (see FIG. 1) storing coffee beans, miso, or other food product from which carbon dioxide gas is generated. The storage bag 10 is constituted of a packaging film layer 1 and a plurality of layers of the degassing sheets 2 adhered to an inner side of the packaging film layer 1 and is closed by heat sealing.

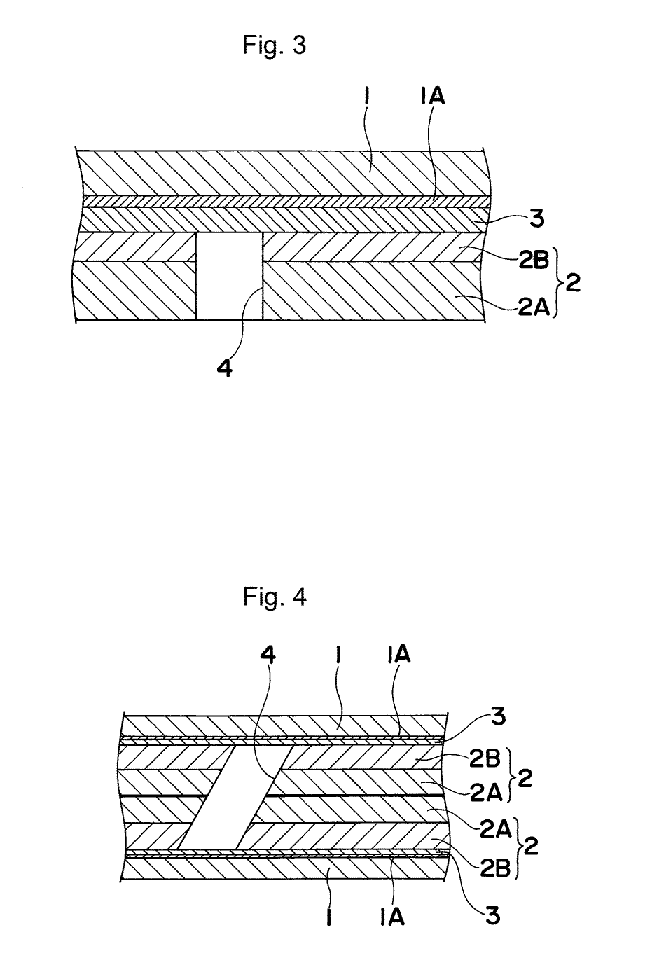

The packaging film layer 1 is formed of polyester with printing 1 A applied thereto and the plurality of degassing sheets 2 are adhered via the adhesion layers 3 to the inner side of the packaging film layer 1 (see FIG. 3).

Each degassing sheet 2 is constituted of a two-layer structure in which the gas-permeable film 2A and the barrier film 2B are laminated. A gas generated in the interior of the packaging bag 10 is discharged upon permeating through the gas-permeable film 2A. On the other hand, when an aluminum deposited layer is used at the barrier film 2B, it is possible to seal aroma, such as that of coffee beans and tea leaves.

Also, the penetrating holes 4 for gas venting are opened in the degassing sheet 2 (see FIG. 2). The penetrating holes 4 are penetrated through the gas-permeable film 2A and the barrier film 2B by a laser irradiated toward the degassing sheet 2. The illustrated penetrating holes 4 are formed as holes of 2 mm width and 3 mm length and at 4 mm intervals at peripheries. The barrier film 2B of the degassing sheet 2 is provided with the adhesion layer 3 adhered onto the packaging film layer 1.

The adhesion layer 3 is a layer adhering the barrier film 2B and the packaging film layer 1 and a pressure-sensitive adhesive is coated on the barrier film 2B side. With the adhesion layer 3, adhered portions 3A, at which the pressure-sensitive adhesive is coated, and the non-adhered portions 3B, at which the adhesive is not coated, form a striped pattern (see FIG. 2). The non-adhered portions 3B form the degassing ports in communication with the exterior of the storage bag 10.

After coating on and drying the pressure-sensitive adhesive, the adhered portions 3A of the adhesion layer 3 are adhered by being pressurized by overlapping and rolling the packaging film layer 1 and the degassing sheet 2 by a roll. Also, the non-adhered portions 3B are in a state of just being press-contacted because the pressure-sensitive adhesive is not coated thereon.

In such an adhesion layer 3, an area ratio of the adhered portions 3A and the non-adhered portions 3B is set to 3 to 2. According to experiments, sufficient degassing could not be accomplished when the area ratio of the adhered portions 3A and the non-adhered portions 3B was set to 2 to 1. Similarly, lowering of adhesion strength was found to occur when the area ratio of the adhered portions 3A and the non-adhered portions 3B was set to 1 to 1.

With such a degassing bag body, carbon dioxide gas generated in the interior of the packaging bag 10 reaches the adhesion layer 3 from the penetrating holes 4 penetrating through the degassing sheet 2 and is discharged to the exterior from the non-adhered portions 3B of the adhesion layer 3 (see FIG. 3). Also, when as in a rear surface portion of the storage bag 10, the gas-permeable films 2A of the degassing sheet 2 are overlapped to form a heat sealed portion 11, the penetrating holes 4 and the gas-permeable films 2A overlap to provide a structure of higher degassing ability (see FIG. 4).

Examples of use of the degassing sheet of the present invention are not restricted to the illustrated example. Also, as food products stored in a bag body or container formed by the degassing sheet of the present invention, various types of food products that generate carbon dioxide, besides coffee beans and miso, may be stored.

The present invention is industrially applicable because it can be valuably used for hunting or sport shooting.

Note that, this invention is not limited to the above-mentioned embodiments. Although it is to those skilled in the art, the following are disclosed as the one embodiment of this invention.
Mutually substitutable members, configurations, etc. disclosed in the embodiment can be used with their combination altered appropriately.
Although not disclosed in the embodiment, members, configurations, etc. that belong to the known technology and can be substituted with the members, the configurations, etc. disclosed in the embodiment can be appropriately substituted or are used by altering their combination.
Although not disclosed in the embodiment, members, configurations, etc. that those skilled in the art can consider as substitutions of the members, the configurations, etc. disclosed in the embodiment are substituted with the above mentioned appropriately or are used by altering its combination.

What is claimed is:

1. A degassing sheet comprising:
a gas-permeable film, having a fully-penetrating or semi-penetrating penetrating hole formed therein; and
a barrier film, provided with an adhesion layer having a paste coated on an inner side; and being arranged so that non-adhered portions, forming a striped pattern, are formed continuously in the adhesion layer of the barrier film and the non-adhered portions form degassing ports between the gas-permeable film, adhered to the adhesion layer, and the barrier film.

2. The degassing sheet according to claim 1, wherein
the gas-permeable film has a thickness of not less than 10 μm and not more than 400 μm.

3. The degassing sheet according to claim 1, wherein
the gas-permeable film is constituted from polyethylene with a density of not more than 0.94.

4. The degassing sheet according to claim 1, wherein
the barrier film is a barrier film selected from among aluminum foil, aluminum deposited film, alumina deposited film, silica deposited film, polyvinyl alcohol film, and vinylidene chloride film.

5. The degassing sheet according to claim 1, wherein
a shape of the penetrating hole provided in the gas-permeable film is elliptical or rectangular.

6. The degassing sheet according to claim 1, wherein
a width of each non-adhered portion of the adhesion layer is from 0.3 mm to 0.95 mm.

7. A degassing bag body using a degassing sheet characterized in being formed using the degassing sheet according to claim 1 so that the barrier film is an outer layer.

8. A degassing container sealing member using a degassing sheet characterized in being formed using the degassing sheet according to claim 1 so that the barrier film is an outer layer.
